(19) United States
(12) Patent Application Publication
(10) Pub. No.: US 2010/0024723 A1
(43) Pub. Date: Feb. 4, 2010

(54) SUBSTRATE ALIGNMENT APPARATUS AND SUBSTRATE PROCESSING APPARATUS

(75) Inventors: Masami Hasegawa, Kunitachi-shi (JP); Kazuaki Kaneko, Fuchu-shi (JP)

Correspondence Address: FITZPATRICK CELLA HARPER & SCINTO, 1290 Avenue of the Americas, NEW YORK, NY, 10104-3800, US

(73) Assignee: CANON ANELVAN CORPORATION, Kawasaki-shi (JP)

(21) Appl. No.: 12/501,827

(22) Filed: Jul. 13, 2009

(30) Foreign Application Priority Data
Jul. 31, 2008 (JP) 2008-197603
Sep. 5, 2008 (JP) 2008-228343
Jun. 30, 2009 (JP) 2009-156298

(51) Int. Cl. B05C 13/00; C23F 1/00

(52) U.S. Cl. 118/500; 156/345.54

(57) ABSTRACT

A substrate alignment apparatus for aligning a substrate with a reference point, comprises a plurality of columns configured to rotate about rotation axes parallel to respective axial directions thereof, a driving mechanism configured to synchronously rotate the plurality of columns through an identical angle in an identical direction, a detector configured to detect an amount of positional deviation of the substrate from the reference point, and support pins which are located on upper surfaces of the plurality of columns while being spaced apart from respective rotation axes of the plurality of columns, and are configured to support the substrate, wherein the substrate is aligned by synchronously rotating the plurality of columns through the identical angle in the identical direction by the driving mechanism based on the amount of positional deviation detected by the detector.

### BACKGROUND OF THE INVENTION

1. Field of the Invention

The present invention relates to a substrate alignment apparatus which corrects the position of a substrate, and a substrate processing apparatus.

2. Description of the Related Art

Patent reference 1 (Japanese Patent Laid-Open No. 9-181151), for example, describes a conventional method of correcting the position of a substrate by mechanically pressing an abutment pin, which abuts against the outer peripheral face of the substrate, against the substrate.

Patent reference 2 (Japanese Patent Laid-Open No. 8-008328) describes a known wafer positioning apparatus which corrects the position of a substrate while the substrate is mounted on an X-Y stage moved in orthogonal directions.

Patent reference 3 (Japanese Patent Laid-Open NO. 2008-66367) describes a substrate transfer apparatus which transfers a substrate between a transport arm which transports the substrate and a mounting table which mounts the substrate. The apparatus described in patent reference 3 is disposed around the support axis of the mounting table with a spacing between them. This apparatus includes a plurality of support pins which support the substrate on its lower surface, and a base to which the support pins are attached. This apparatus also includes a vertical driving means for vertically driving the support pins through the base to lift and lower the substrate, and a horizontal driving means for horizontally driving the support pins through the base to adjust the position of the substrate in the horizontal direction.

The substrate position correction method according to patent reference 1 is likely to generate particles because it corrects the position of a substrate by mechanically pushing the substrate by pressing, e.g., an abutment pin against the side surface (outer peripheral face) of the substrate. This method also poses a problem that particles are often generated due to rubbing of the lower surface of the substrate on the support pins mounting the substrate in the process of moving the substrate while it is pressed against the abutment pin.

Although the wafer positioning apparatus according to patent reference 2 can solve the foregoing problem that particles are generated due to rubbing of the substrate, it requires an X-Y stage and two driving systems in the X and Y directions in order to drive the X-Y stage. Furthermore, this apparatus is unsuitable for accommodation in a compact space because it is necessary to secure a given space around the X-Y stage so that no interference takes place even when the X-Y stage is translated in the horizontal direction (the X and Y directions).

The substrate transfer apparatus according to patent reference 3 requires forming, in the mounting table, clearances to allow the moved support pins to run out. If extra clearances are formed inside a mounting table accommodated in, for example, a substrate processing apparatus which performs substrate processing using a plasma, this apparatus may face problems associated with temperature distribution and RF nonuniformities. Also, if a mechanism including the foregoing components involved in the substrate transfer and processing is installed inside a vacuum chamber, this may pose problems associated with its installation space, scattering of lubricants and particles, and outgassing.

To move the support pins in a vacuum in the vertical direction and the horizontal direction, i.e., the X and Y directions, it is necessary to set the driving systems on the atmospheric side and perform these movements through a vacuum wall. A bellows is generally used in the vertical movement. At this time, when the bellows vertically extends/contracts while being shifted in the horizontal direction, a load is imposed on the weld zone of the bellows, leading to significant shortening of the lifetime of the substrate transfer apparatus.

### SUMMARY OF THE INVENTION

It is an object of the present invention to provide a substrate alignment apparatus and substrate processing apparatus which can suppress the generation of particles, are compact, and/or have a long lifetime.

The first aspect of the present invention provides a substrate alignment apparatus for aligning a substrate with a reference point, the apparatus comprising a plurality of columns configured to rotate about rotation axes parallel to respective axial directions thereof, a driving mechanism configured to synchronously rotate the plurality of columns through an identical angle in an identical direction, a detector configured to detect an amount of positional deviation of the substrate from the reference point, and support pins which are located on upper surfaces of the plurality of columns while being spaced apart from respective rotation axes of the plurality of columns, and are configured to support the substrate, wherein the substrate is aligned by synchronously rotating the plurality of columns through the identical angle in the identical direction by the driving mechanism based on the amount of positional deviation detected by the detector.

The second aspect of the present invention provides a substrate processing apparatus comprising a substrate alignment apparatus as defined above.

According to the present invention, it is possible to provide a substrate alignment apparatus which can suppress the generation of particles, is compact, and/or has a long lifetime because it corrects the position of a substrate by rotating a support pin while the substrate is mounted on the support pin.

Further features of the present invention will become apparent from the following description of exemplary embodiments with reference to the attached drawings.

### BRIEF DESCRIPTION OF THE DRAWINGS

FIG. 1 is a perspective view showing a substrate alignment apparatus according to the first embodiment of the present invention;

FIGS. 2A to 2H are views for explaining the position correction procedure of the substrate alignment apparatus shown in FIG. 1;

FIG. 3 is a view for explaining a substrate positional deviation detection method;

FIG. 4 is a view for explaining substrate position correction;

FIG. 5 is a view illustrating an example of a support pin driving mechanism;

FIG. 6 is a schematic perspective view illustrating an example of a synchronous rotation mechanism for synchronously rotating three columns;

FIGS. 7A to 7D are views illustrating examples of a support pin;

FIG. 8 is a perspective view showing the arrangement of a substrate alignment apparatus according to the second embodiment of the present invention;

FIGS. 9A to 9I are views for explaining the position correction procedure of the substrate alignment apparatus shown in FIG. 8;

FIG. 10 is a view showing the arrangement of a substrate alignment apparatus according to the third embodiment of the present invention;

FIGS. 11A to 11G are views for explaining the position correction procedure of the substrate alignment apparatus shown in FIG. 10;

FIGS. 12H to 12K are views for explaining the position correction procedure of the substrate alignment apparatus shown in FIG. 10;

FIG. 13 is a schematic perspective view showing a substrate processing apparatus according to the first embodiment of the present invention;

FIG. 14 is a conceptual view of substrate detection in the substrate processing apparatus according to the first embodiment of the present invention;

FIG. 15 is a view for explaining the arrangement of optical displacement sensors used in the substrate processing apparatus according to the first embodiment of the present invention;

FIG. 16 is a top view of substrate positional deviation detection by the optical displacement sensors of the substrate processing apparatus according to the present invention when viewed from above the substrate;

FIG. 17A is a schematic view showing a state in which the optical displacement sensors detect a substrate positional deviation;

FIG. 17B is a schematic view showing another state in which the optical displacement sensors detect a substrate positional deviation;

FIG. 17C is a schematic view showing a still another state in which the optical displacement sensors detect a substrate positional deviation;

FIG. 17D is a schematic view showing a still another state in which the optical displacement sensors detect a substrate positional deviation;

FIG. 18 is a schematic perspective view showing a substrate processing apparatus according to the second embodiment of the present invention;

FIGS. 19A and 19B are views for explaining the arrangement of a transmissive optical displacement sensor used in the substrate processing apparatus according to the second embodiment of the present invention;

FIG. 20 is a view for explaining substrate positional deviation detection using the transmissive optical displacement sensor; and

FIG. 21 is a top view of substrate positional deviation detection by the transmissive optical displacement sensors when viewed from above the substrate.

### DESCRIPTION OF THE EMBODIMENTS

Best modes for carrying out the invention will be described in detail below with reference to the accompanying drawings.

### First Embodiment

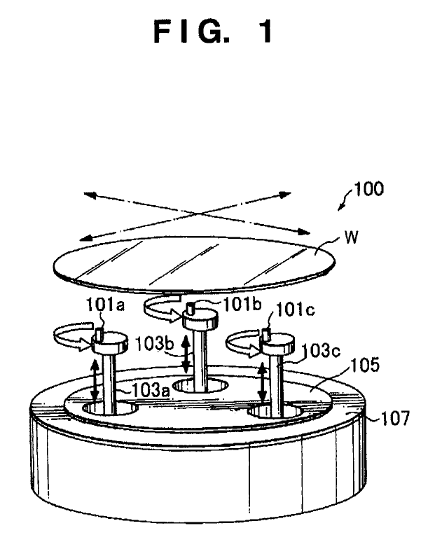

FIG. 1 is a perspective view showing a substrate alignment apparatus according to the first embodiment of the present invention. The substrate alignment apparatus according to the present invention moves a horizontally supported substrate in the horizontal direction so that the substrate aligns with a predetermined reference point, and corrects a substrate positional deviation, thereby precisely mounting the substrate on a substrate holder.

A substrate alignment apparatus 100 includes a substrate holder 105 which mounts a substrate (e.g., a semiconductor wafer) W, and a plurality of columns 103, i.e., 103a, 103b, and 103c which are set in the substrate holder 105 and are configured to be freely rotatable and movable in the vertical direction while supporting the substrate W. The plurality of columns 103 rotate about their respective rotation axes parallel to a normal to the substrate W to be supported.

The plurality of columns 103 include, on their upper surfaces (rotation surfaces), support pins 101a, 101b, and 101c located at positions decentered from the respective rotation axes of the plurality of columns 103. The substrate alignment apparatus 100 also includes a ring-shaped cover 107 which shields the substrate holder 105. Although FIG. 1 shows only a substrate alignment apparatus according to the present invention, it is in practice built in a substrate processing apparatus which performs substrate processing using a plasma.

In this embodiment, the columns 103a, 103b, and 103c are set inside the ring-shaped cover 107. The substrate alignment apparatus 100 is placed in a vacuum chamber (not shown) which constitutes the substrate processing apparatus. Although the number of columns 103 can be three, it is not limited to this, and an arbitrary number of columns 103 may be used as long as they can horizontally hold the substrate W.

The columns 103a, 103b, and 103c include, on their upper surfaces (rotation surfaces), the three support pins 101a, 101b, and 101c located at positions decentered from the respective rotation axes of the columns 103a, 103b, and 103c by the same radius. That is, the three support pins 101 are located at positions spaced apart from the rotation axes (rotation centers) of the columns 103 on their rotation surfaces by a predetermined distance (the same distance). Although the rotation surfaces of the columns 103 can have a disk shape, they are not limited to this, and may have, for example, a square shape or a rectangular shape.

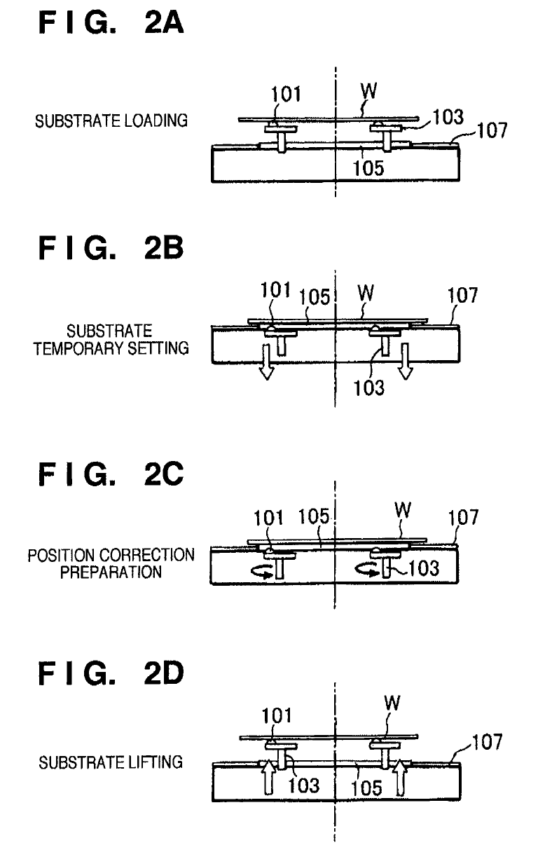

The procedure for substrate position correction using the substrate alignment apparatus according to this embodiment will be explained with reference to FIGS. 2A to 2H. First, a substrate W is transported into a vacuum chamber by a substrate transport mechanism (not shown), and mounted on the columns 103a, 103b, and 103c lying at lifted positions, as shown in FIG. 2A (substrate loading).

The mounted substrate W may have a positional deviation at this time, so it is corrected as will be explained hereinafter. The substrate W is mounted on the substrate holder 105 by synchronously lowering the three columns 103a, 103b, and 103c, as shown in FIG. 2B (substrate temporary setting).

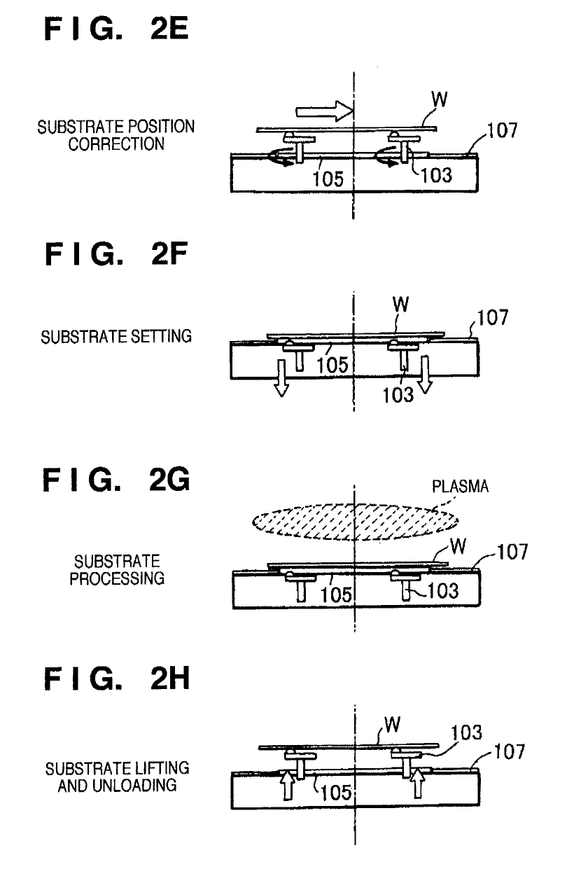

After the temporary setting of the substrate W is completed, position correction preparation of the substrate W is performed by detecting the amount of substrate positional deviation (FIG. 2C). A method of detecting a positional deviation of the substrate W mounted on the substrate holder 105 will be explained herein various methods of detecting a positional deviation of the substrate W are available. For example, the center X of the substrate W is determined based on the data captured by a CCD camera from above the substrate W, as shown in FIG. 3.

The center X of the substrate W is compared with a predetermined reference point X′ to obtain an amount of movement L (an absolute value X-X′) and the moving direction (a vector XX′) of the substrate W. Note that the outer edge of the substrate W may be moved to its corresponding reference point in place of the center of the substrate W.

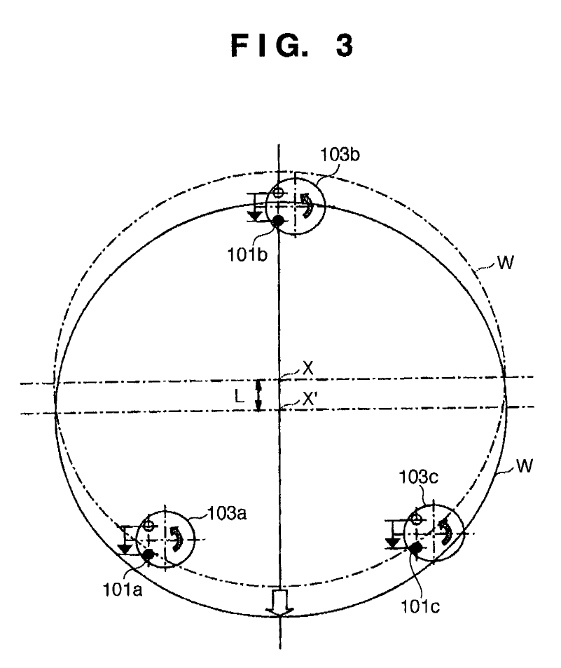

An angle 2θ through which the columns 103a, 103b, and 103c, i.e., the support pins 101a, 101b, and 101c of the substrate alignment apparatus 100 are rotated about the respective column centers is calculated, as shown in FIG. 4.

As the moving direction and the amount of movement L are determined upon detecting the amount of substrate positional deviation, we have relations between the amount of movement L and the angle 2θ:

sin θ=L/2R

θ=sin⁻¹(L/2R)

2θ=2 sin⁻¹(L/2R)

where R is the distance between the rotation axis (rotation center) of the column 103 and the center of the support pin 101, as shown in FIG. 4; and θ is the angle formed between a virtual line I which is perpendicular to the substrate moving direction indicated by an arrow in FIG. 4 and passes through the rotation center of the column 103, and a straight line m which passes through the center of the column 103 and one of the centers of the support pin 101 before and after the movement. The support pin positions before and after the movement have the same angle θ and are axisymmetrical about the virtual line I which is perpendicular to the substrate moving direction and passes through the rotation axis of the column 103.

An arithmetic circuit using, e.g., a CPU (not shown) performs the foregoing calculation.

A virtual line I perpendicular to the moving direction of the substrate W is assumed for each of the columns 103 while they are not in contact with the substrate W, as shown in FIG. 2C. The columns 103a, 103b, and 103c, i.e., the support pins 101a, 101b, and 101c are rotated to the support pin positions before the movement, which form the angle θ with respect to the virtual lines I, about their respective centers.

This is done in preparation for position correction of the substrate W by moving the support pins 101 before aligning the substrate W. That is, the support pins 101 are moved to their previous positions (before the movement) without supporting the substrate W, as shown in FIG. 4.

In this way, the support pins 101a, 101b, and 101c are fixed in position at the angle θ with respect to the virtual lines I about their respective rotation axes. In this state, the three columns 103a, 103b, and 103c are synchronously lifted while the substrate W is supported by the support pins 101a, 101b, and 101c, as shown in FIG. 2D (substrate lifting).

In this state, the three columns 103a, 103b, and 103c are synchronously rotated through the same angle 20 in the same direction, as shown in FIG. 2E. With this operation, the substrate W supported by the support pins 101 moves by the amount of movement L in the direction in which a positional deviation of the substrate W is corrected (substrate position correction). In this case, the support pins 101 are moved by the amount of movement L from their positions before the movement to those after the movement, as shown in FIG. 4. By this alignment, the position of the substrate W is corrected so that the center X of the substrate W shown in FIG. 3 aligns with the predetermined reference point X′.

The substrate W is mounted on the substrate holder 105 by lowering the columns 103 while supporting the substrate W, as shown in FIG. 2F (substrate setting), and the position correction operation is completed. In this correction method, the maximum moving range of the substrate is determined depending on the radius of the columns and is maximum when 2θ=180°. Hence, an optimum radius need only be selected in accordance with the amount of positional deviation to be corrected such that it conforms to the specification of the substrate processing apparatus.

A plasma is generated by a plasma generation unit (not shown) in the vacuum chamber of the substrate processing apparatus to process the substrate W, as shown in FIG. 2G. To unload the substrate W to, e.g., another vacuum chamber, a substrate unloading mechanism (not shown) unloads the substrate W after the columns 103 are lifted, as shown in FIG. 2H.

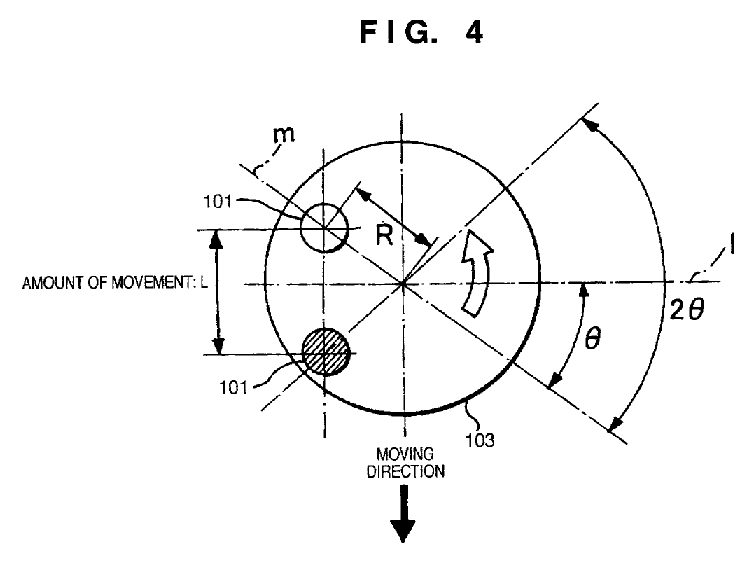

FIG. 5 illustrates an example of a driving mechanism of the column 103. The same reference numerals as in FIG. 1 denote the same parts in FIG. 5, and a description thereof will not be given. The column 103 has one end connected to a positioning motor 509 in order to rotate the column 103. The column 103 is connected to a vertical cylinder 507 to be movable vertically.

A magnetic fluid seal (or a magnetic coupling seal) 505 is interposed between the column 103 and the positioning motor 509 in order to apply a driving force into the chamber through a chamber wall 501 without breaking the vacuum. That is, the magnetic fluid seal (or the magnetic coupling seal) 505 isolates the air and the vacuum inside the chamber. Although FIG. 5 shows the driving structure of only one column 103, the same driving mechanism applies to the plurality of columns 103. Referring to FIG. 5, reference numeral 503 denotes a bellows.

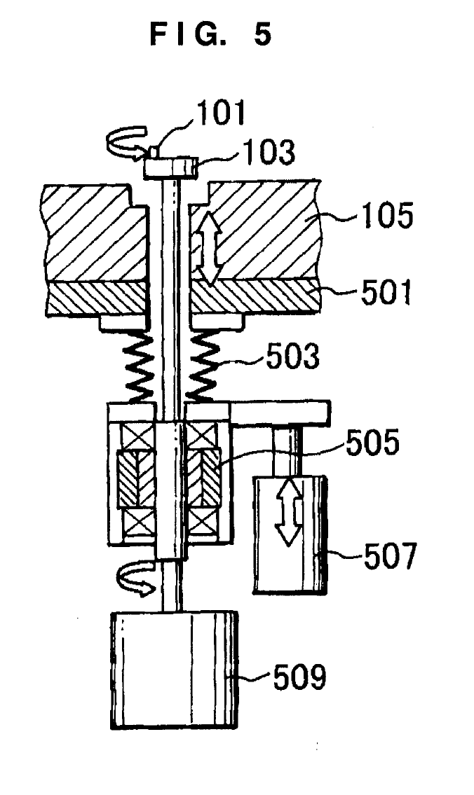

FIG. 6 is a schematic perspective view illustrating one example of a rotation driving mechanism for synchronously rotating the three columns 103a, 103b, and 103c, which have been described with reference to FIG. 2E, through the same angle in the same direction. The same reference numerals as in FIG. 1 denote the same parts in FIG. 6. A single timing belt 601 drives one end of each of the three columns 103a, 103b, and 103c, as shown in FIG. 6. This mechanism includes a positioning motor 603 for rotating the timing belt 601. The three columns 103a, 103b, and 103c can be synchronously rotated through the same angle in the same direction by driving the positioning motor 603 to rotate the timing belt 601.

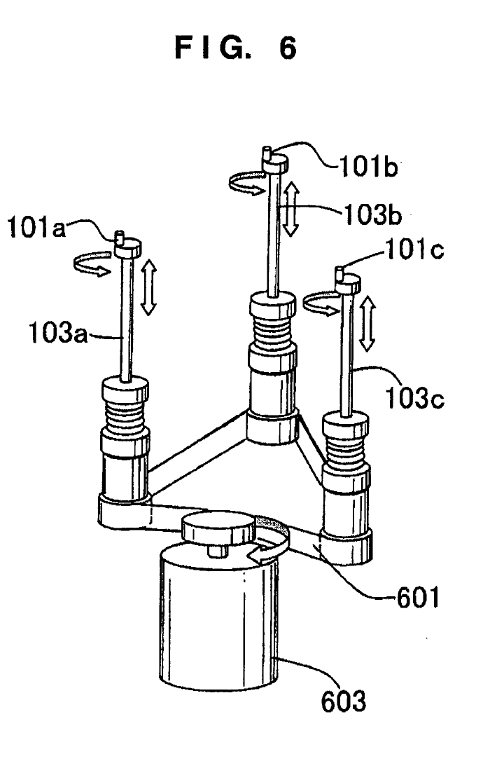

FIGS. 7A to 7D show the shapes of the support pin 101, which are applicable to the present invention. FIG. 7A illustrates an example in which the support pin 101 has a conical distal end, FIG. 7B illustrates an example in which the support pin 101 has a semispherical shape. Alternatively, the support pin 101 may have a cylindrical structure with a minimum area, as shown in FIG. 7C. That is, FIG. 7C shows a structure in which the distal end of the support pin falls within the region on the column 103.

FIG. 7D illustrates an example in which the support pin 101 has a cylindrical structure which is freely rotatable about a rotation axis parallel to the axial direction of the support pin 101. The structure shown in FIG. 7D is especially effective in preventing the generation of any particles because it can reduce friction with the substrate W.

According to the first embodiment, the position of the substrate W is corrected by rotating the support pins while the substrate W is mounted on the support pins. This makes it possible to reduce, e.g., rubbing between the substrate W and the support pins, and therefore to suppress the generation of any particles. It is also possible to achieve a compact alignment apparatus because no wide space to correct a positional deviation is necessary. Moreover, the lifetime of the substrate alignment apparatus according to this embodiment is less likely to shorten than that of the substrate transfer apparatus described in patent reference 3.

### Second Embodiment

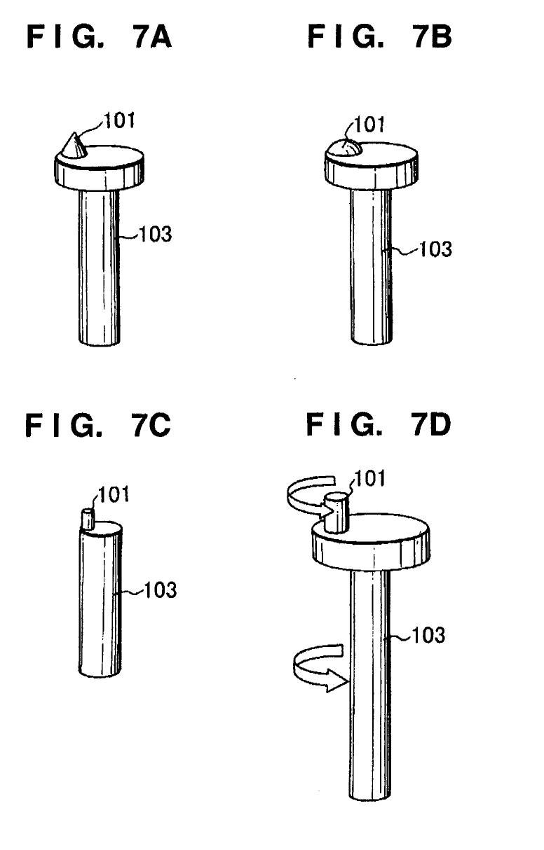

The arrangement of a substrate alignment apparatus according to the second embodiment of the present invention will be described next with reference to FIG. 8. The same reference numerals as in FIG. 1 denote the same parts in FIG. 8, and a description thereof will not be given. Although the basic configuration of the substrate alignment apparatus shown in FIG. 8 is the same as that shown in FIG. 1, columns 103a, 103b, and 103c are set outside a substrate holder 105 in order to lift up a ring-shaped cover 107 in this embodiment.

The inner periphery of the ring-shaped cover 107 is smaller than the outer periphery of a substrate W. For this reason, as the plurality of columns 103a, 103b, and 103c rise, the substrate W also rises together with the ring-shaped cover 107. The substrate holder 105 is attached with lift pins 901a, 901b, and 901c for lifting up the substrate W. A lifting/lowering mechanism (not shown) can vertically move the lift pins 901, as indicated by two-headed arrows in FIG. 8. Support pins 101a, 101b, and 101c are located on the rotation surfaces of the columns 103a, 103b, and 103c while being spaced apart from a predetermined distance from their respective rotation axes, as in the case shown in FIG. 1.

In this manner, setting the columns 103a, 103b, and 103c outside the substrate holder 105 obviates the need to provide the substrate holder 105 with a complex mechanism for rotating and vertically moving the columns 103. This is very effective when it is necessary to provide the substrate holder 105 with, e.g., a temperature control mechanism for controlling the substrate to have a uniform temperature, and an electrostatic chucking mechanism for holding the substrate by an electrostatic attraction force.

Also in this embodiment, a driving mechanism of the column 103 can be the one shown in FIG. 5, and a rotation driving mechanism which synchronously rotates the three columns 103 through the same angle in the same direction can be the one shown in FIG. 6. The support pins 101 can have several shapes shown in FIGS. 7A to 7D as needed.

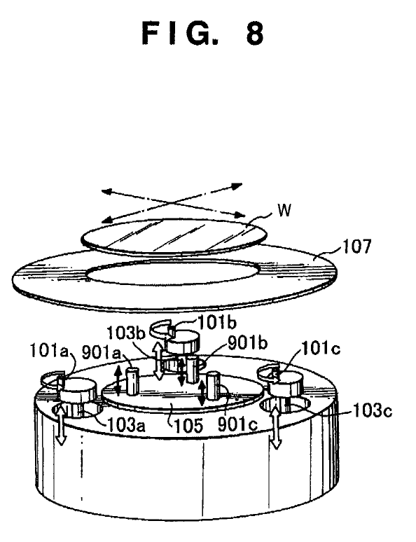

The procedure for substrate position correction using the substrate alignment apparatus according to this embodiment will be explained with reference to FIGS. 9A to 9I. First, a substrate W is transported into a vacuum chamber by a substrate transport mechanism (not shown), and mounted on the lift pins 901a, 901b, and 901c lying at lifted positions, as shown in FIG. 9A.

The mounted substrate W may have a positional deviation at this time, so the amount of positional deviation, i.e., the amount of movement L and the moving direction of the substrate W are detected by the method of detecting a positional deviation of the substrate W, which has been described with reference to FIG. 3.

An angle 20 through which the columns 103a, 103b, and 103c, i.e., the support pins 101a, 101b, and 101c of a substrate alignment apparatus 100 are rotated about the rotation axes of the columns 103a, 103b, and 103c (column centers) is calculated, as has been described with reference to FIG. 4.

A virtual line I perpendicular to the moving direction of the substrate W is assumed for each of the columns 103a, 103b, and 103c while they are not in contact with the ring-shaped cover 107, as in the case described with reference to FIG. 2C. The columns 103a, 103b, and 103c, i.e., the support pins 101a, 101b, and 101c are rotated to the support pin positions before the movement, which form the angle θ with respect to the virtual lines I, about their respective centers.

In this way, the support pins 101a, 101b, and 101c are fixed in position at the angle θ with respect to the virtual lines I about their respective rotation axes. In this state, the three columns 103a, 103b, and 103c are synchronously lifted while the ring-shaped cover 107 and the substrate W are supported by the support pins 101a, 101b, and 101c, as shown in FIG. 9B. At this time, the columns 103 are lifted up to the positions at which the substrate W and the lift pins 901 separate from each other.

In this state, the three columns 103a, 103b, and 103c are synchronously rotated through the same angle 20 in the same direction, as shown in FIG. 9C. With this operation, the ring-shaped cover 107 and substrate W supported by the support pins 101a, 101b, and 101c move by the amount of movement L in the direction in which a positional deviation of the substrate W is corrected. This operation is the same as in FIG. 2E.

The three columns 103a, 103b, and 103c are synchronously lowered up to the positions at which the substrate W is mounted on the lift pins 901, as shown in FIG. 9D. The columns 103a, 103b, and 103c are further synchronously lowered up to the positions at which the substrate W and the ring-shaped cover 107 separate from each other.

The ring-shaped cover 107 is rotated so as to return to its initial position by synchronously rotating the three columns 103a, 103b, and 103c through the same angle (−2θ) in the same direction, as shown in FIG. 9E. In addition, the ring-shaped cover 107 is mounted on the substrate holder 105 by synchronously lowering the three columns 103a, 103b, and 103c, as shown in FIG. 9F. Then, the substrate W is mounted on the substrate holder 105 by lowering the lift pins 901a, 901b, and 901c, as shown in FIG. 9G.

After that, a plasma is generated in the vacuum chamber to process the substrate W, as shown in FIG. 9H. To unload the substrate W to, e.g., another vacuum chamber, a substrate unloading mechanism (not shown) unloads the substrate W after it is lifted up to its transport position by lifting the lift pins 901, as shown in FIG. 9I.

According to the second embodiment, it is possible to reduce, e.g., rubbing between the substrate W and the support pins, and therefore to suppress the generation of any particles, as in the first embodiment. It is also possible to achieve a compact alignment apparatus. Moreover, there is no need to provide the inner region of the substrate holder 105 with a complex mechanism for rotating and vertically moving the columns 103. This is very effective when it is necessary to provide the inner region of the substrate holder 105 with, e.g., a temperature control mechanism and an electrostatic chucking mechanism.

### Third Embodiment

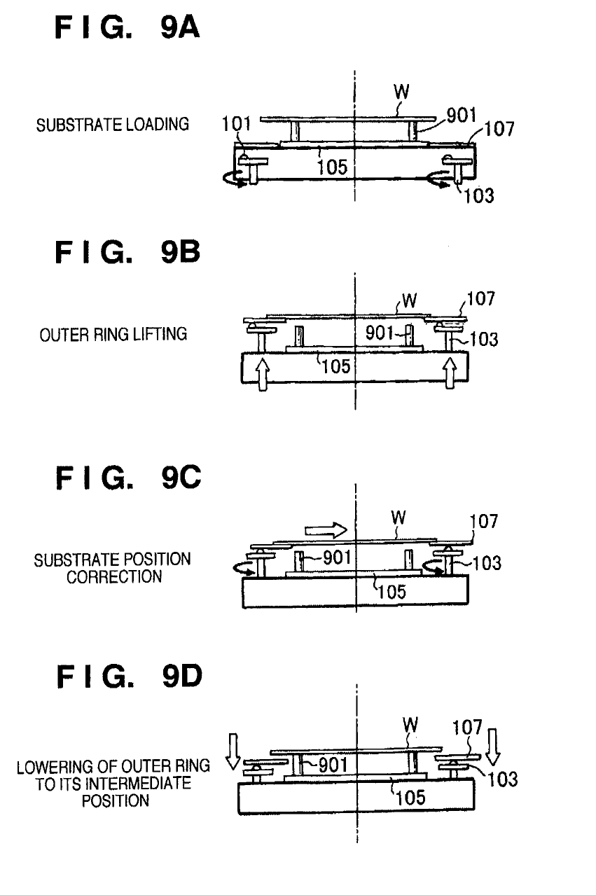

The arrangement of a substrate alignment apparatus according to the third embodiment of the present invention will be described next with reference to FIG. 10. The same reference numerals as in FIGS. 1 and 8 denote the same parts in FIG. 10, and a description thereof will not be given. The basic configuration of the substrate alignment apparatus shown in FIG. 10 is the same as those shown in FIGS. 1 and 8. In this embodiment, support pins 101, i.e., 101a, 101b, and 101c are freely rotatable about rotation axes parallel to their axial directions, and columns 103, i.e., 103a, 103b, and 103c are freely rotatable about rotation axes parallel to their axial directions. Also, the support pins 101, i.e., 101a, 101b, and 101c are connected to a ring-shaped cover 107, A structure in which the support pins 101a, 101b, and 101c are freely rotatable with respect to the columns 103a, 103b, and 103c, respectively, is the one shown in FIG. 7D.

In another example, the support pins 101, i.e., 101a, 101b, and 101c may be freely rotatable with respect to the ring-shaped cover 107 about rotation axes parallel to their axial directions, and be connected to the columns 103, i.e., 103a, 103b, and 103c.

In this structure, the respective columns (including the support pins) and the ring-shaped cover are connected to or engage with each other. Hence, the substrate alignment apparatus shown in FIG. 10 allows substrate position correction with an accuracy higher than that of the substrate alignment apparatus shown in FIG. 8.

Also in this embodiment, a driving mechanism of the column 103 can be the one shown in FIG. 5, and a rotation driving mechanism which synchronously rotates the three columns 103 through the same angle in the same direction can be the one shown in FIG. 6.

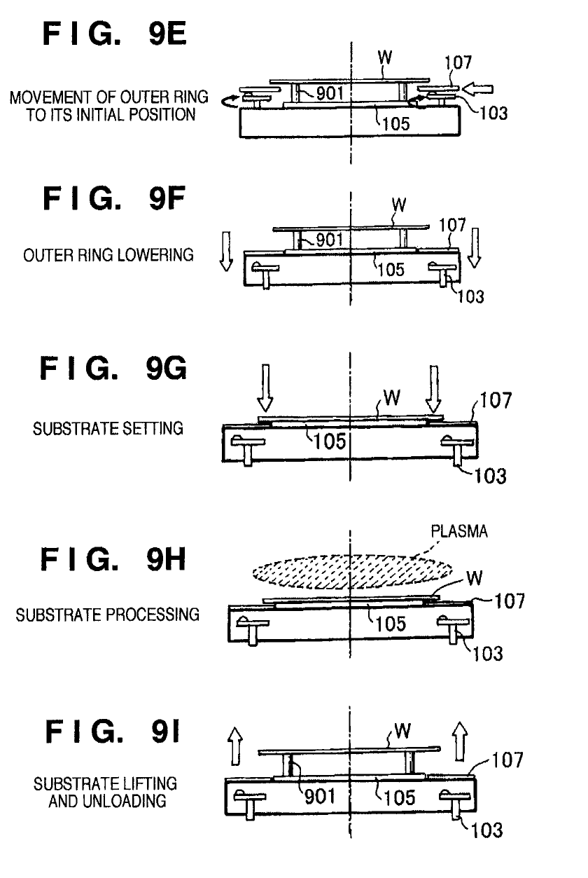

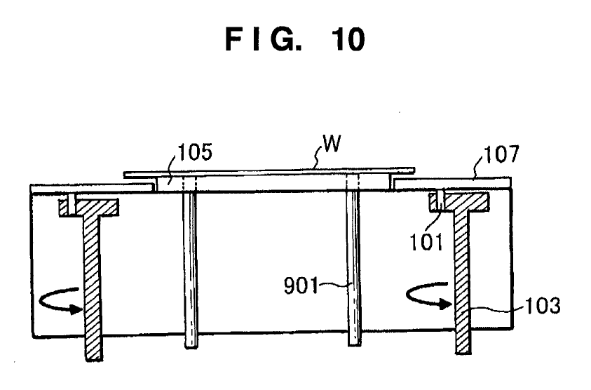

The procedure for substrate position correction using the substrate alignment apparatus according to this embodiment will be explained with reference to FIGS. 11A to 11G and 12H to 12K. The correction procedure continues from FIGS. 11A to 11G to FIGS. 12H to 12K. First, a substrate W is transported into a vacuum chamber by a substrate transport mechanism (not shown), and mounted on lift pins 901a, 901b, and 901c lying at lifted positions, as shown in FIG. 11A.

The mounted substrate W may have a positional deviation at this time, so the amount of positional deviation, i.e., the amount of movement L and the moving direction of the substrate W are detected by the method of detecting a positional deviation of the substrate W, which has been described with reference to FIG. 3.

An angle 2θ through which the columns 103a, 103b, and 103c, i.e., the support pins 101a, 101b, and 101c of a substrate alignment apparatus 100 are rotated about the centers of the columns 103a, 103b, and 103c is calculated, as has been described with reference to FIG. 4.

The three columns 103a, 103b, and 103c are synchronously lifted to the positions at which the ring-shaped cover 107 connected to the support pins 101a, 101b, and 101c comes out of contact with the substrate W and a substrate holder 105, as shown in FIG. 11B. A virtual line I perpendicular to the moving direction of the substrate W is assumed for each of the columns 103a, 103b, and 103c, as in the case described with reference to FIG. 2C.

Note, however, that the support pins 101a, 101b, and 101c and the ring-shaped cover 107 are connected to each other in this case. The columns 103, i.e., the support pins 101a, 101b, and 101c are rotated to the support pin positions before the movement, which form the angle 0 with respect to the virtual lines I, about their respective centers, as shown in FIG. 11C.

In this way, the support pins 101a, 101b, and 101c are fixed in position at the angle 0 with respect to the virtual lines I about their respective centers. In this state, the three columns 103a, 103b, and 103c are synchronously lifted while the substrate W is supported by the ring-shaped cover 107 connected to the support pins 101a, 101b, and 101c, as shown in FIG. 11D. At this time, the columns 103 are lifted up to the positions at which the substrate W and the lift pins 901 separate from each other.

In this state, the three columns 103a, 103b, and 103c are synchronously rotated through the same angle 2θ in the same direction, as shown in FIG. 11E. With this operation, the substrate W supported by the ring-shaped cover 107 connected to the support pins 101a, 101b, and 101c move by an amount of movement L in the direction in which a positional deviation of the substrate W is corrected. This operation is the same as in FIG. 2E.

The three columns 103a, 103b, and 103c are synchronously lowered up to the positions at which the substrate W is mounted on the lift pins 901. The three columns 103a, 103b, and 103c are further synchronously lowered up to the positions at which the substrate W and the ring-shaped cover 107 separate from each other, as shown in FIG. 11F. These positions may be the same as those in the state shown in FIG. 11B.

The three columns 103a, 103b, and 103c are synchronously rotated through the same angle in the same direction so that they return to their positions before the position correction preparation in FIG. 11C, i.e., so that the ring-shaped cover 107 returns to its initial position, as shown in FIG. 11G. In addition, the ring-shaped cover 107 is mounted on the substrate holder 105 by synchronously lowering the three columns 103a, 103b, and 103c r as shown in FIG. 12H. Then, the substrate W is mounted on the substrate holder 105 by lowering the lift pins 901a, 901b, and 901c, as shown in FIG. 12I.

After that, a plasma is generated in the vacuum chamber to process the substrate W, as shown in FIG. 12J. To unload the substrate W to, e.g., another vacuum chamber, a substrate unloading mechanism (not shown) unloads the substrate W after it is lifted up to its transport position by lifting the lift pins 901, as shown in FIG. 12K.

According to the third embodiment, there is no need to provide the inner region of the substrate holder 105 with a complex mechanism for rotating and vertically moving the columns 103, as in the second embodiment. This is very effective when it is necessary to provide the inner region of the substrate holder 105 with, e.g., a temperature control mechanism and an electrostatic chucking mechanism.

Moreover, the substrate alignment-apparatus according to this embodiment has a structure in which the respective columns (including the support pins) and the ring-shaped cover are connected to or engage with each other. Hence, the substrate alignment apparatus shown in FIG. 10 allows substrate position correction with an accuracy higher than that of the substrate alignment apparatus shown in FIG. 8.

### First Embodiment

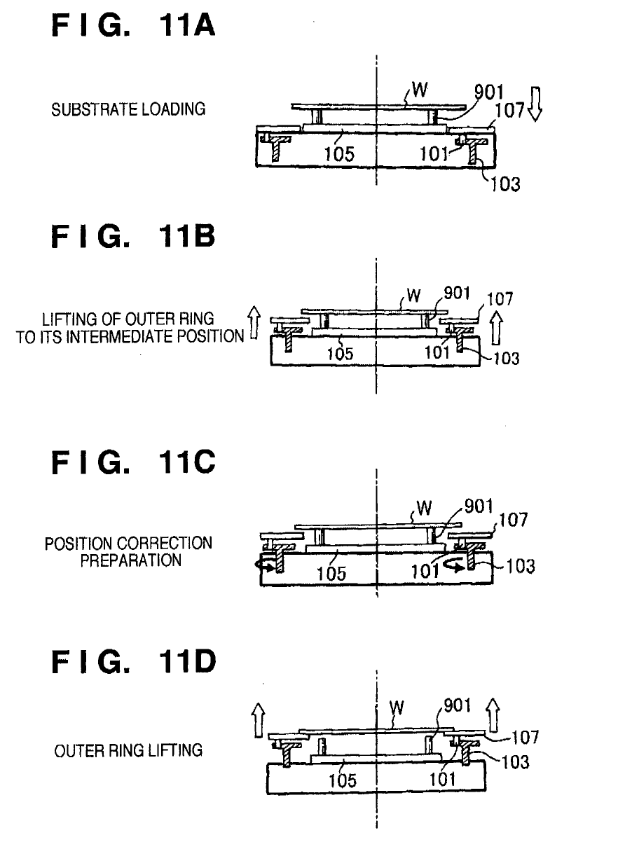

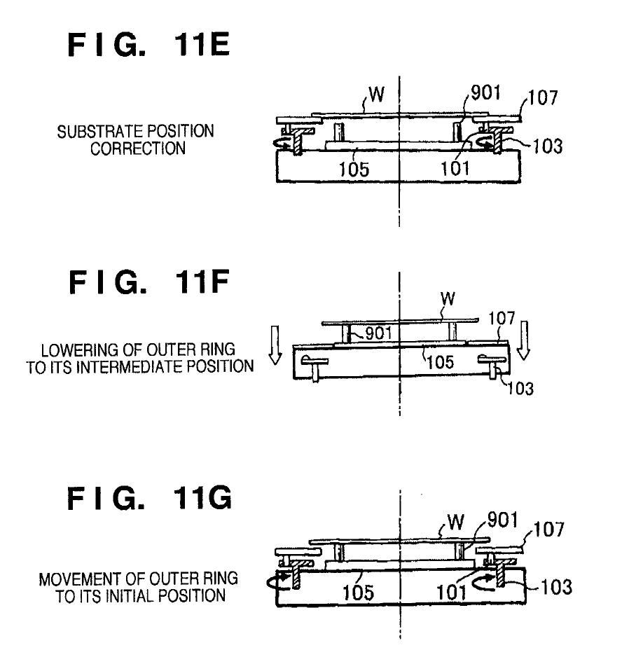

Although a method of detecting a positional deviation of the substrate W has been described previously with reference to FIG. 2C, a more detailed description thereof will be given herein. The arrangement of a substrate processing apparatus to which the present invention is applied will be described below with reference to FIGS. 13 and 14,

FIG. 13 is a schematic perspective view showing a substrate processing apparatus 110 according to the first embodiment of the present invention. FIG. 14 is a conceptual view of substrate detection in the substrate processing apparatus 110 according to the first embodiment of the present invention. The substrate processing apparatus 110 according to this embodiment includes a substrate processing chamber 100 for processing a substrate in a vacuum. The substrate processing chamber 100 accommodates an electrostatic chucking stage 107 which holds a substrate W by chucking using an electrostatic attraction force. The electrostatic chucking stage 107 includes a lifting mechanism 105 including lift pins attached to be liftable. Positional deviation detection units for detecting positional deviations of the substrate W are disposed outside the substrate processing chamber 100. The positional deviation detection units can have optical axes running parallel to the surface of the substrate W. In this embodiment, two or more optical displacement sensors 101 and 103 such as optical laser displacement sensors are used as positional deviation detection units. Each of the optical displacement sensors 101 and 103 includes a light-projecting unit and light-receiving unit, and serves as a reflective optical displacement sensor which detects the light reflected by the substrate W. The substrate processing apparatus 110 also includes a control device 200 (see FIG. 14) which issues a substrate position correction command to a substrate transport unit 202 so as to cancel the amount of positional deviation between the reference position of the substrate W and the position of the substrate W measured by the positional deviation detection unit.

When the substrate W lies at the substrate loading/unloading position above the electrostatic chucking stage 107, a lifting mechanism 105 supports and mounts the substrate W on the electrostatic chucking stage 107. In contrast to this, when the substrate W is mounted on the electrostatic chucking stage 107, the lifting mechanism 105 removes the substrate W from the electrostatic chucking stage 107 and pushes it up to the substrate loading/unloading position.

In this embodiment, at least two optical displacement sensors 101 and 103 are disposed outside the substrate processing chamber 100, and measure the positions of the substrate W through viewing windows (not shown) formed in the wall surrounding the substrate processing chamber 100. This is to prevent the problems that the sensors break down upon being subjected to a plasma and a process gas, and the gases discharged from them adversely affect the film adhered on the substrate. The windows are desirably shielded by movable shields or shutters during the film formation process in order to avoid the situation in which the measurement becomes impossible as the film adheres onto the windows and shields the light during the measurement as a result of the film formation process. The optical displacement sensors 101 and 103 are disposed such that light beams 111 from these sensors are directed parallel to the surface of the substrate W.

Note that two optical displacement sensors need only be used if individual substrates W have the same outer diameter, but three or more optical displacement sensors need to be used if individual substrates W have different outer diameters. Although two optical displacement sensors can measure the substrate positions with highest accuracy when they are disposed at the positions at which light beams 111 from them have optical axes orthogonal to each other and never impinge on the notch or orientation flat at the edge of the substrate such as a wafer, the arrangement of two optical displacement sensors is not limited to this.

The optical displacement sensors 101 and 103 are electrically connected to the control device 200, as shown in FIG. 14. The control device 200 issues a position correction command to the substrate transport unit 202 in accordance with deviations between the reference position information of the substrate W stored in advance and the pieces of position information measured by the optical displacement sensors 101 and 103.

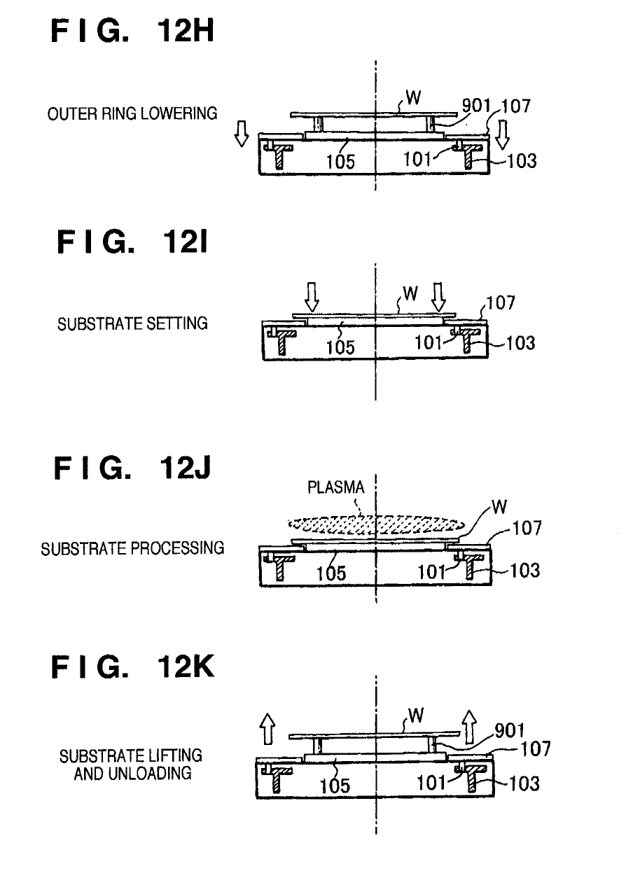

Optical displacement sensors will be explained with reference to FIG. 15. Each of the optical displacement sensors 101 and 103 exploits triangulation and includes a combination of a light-projecting unit including a light-emitting element, and a light-receiving unit including an optical position detection element (PSD), as shown in FIG. 15. A semiconductor laser 301 is used as the light-emitting element. Light emitted by the semiconductor laser 301 driven by a driving circuit 302 is converged via a light-projecting lens 303 and is guided to a measurement object (substrate) 304. The light beam which is diffusely or regularly reflected by the measurement object 304 partially forms a focal spot on a light position detection element 306 via a light-receiving lens 305. Since the spot moves along with the movement of the measurement object 304, the amount of displacement from a reference position 307 to the position of the measurement object 304 can be determined by detecting the spot position. The thus detected substrate position information is amplified by a signal amplifying circuit 308 and sent to the control device 200 (see FIG. 14).

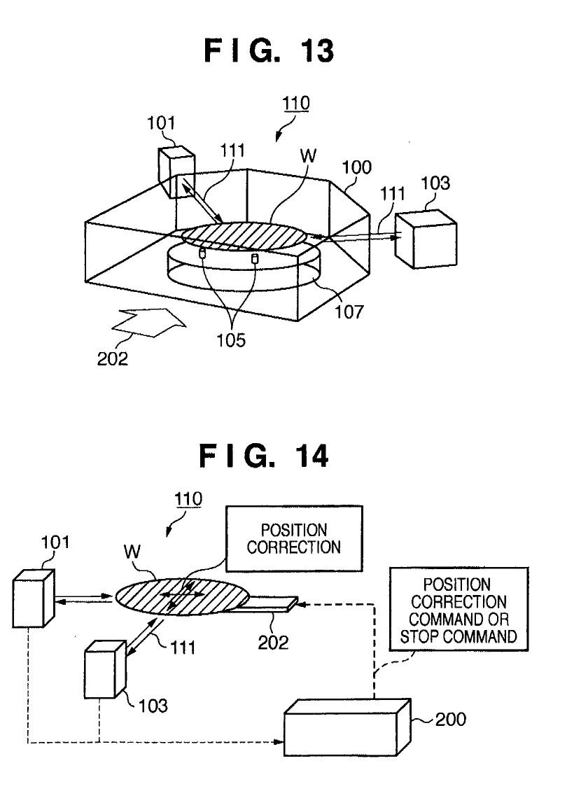

FIG. 16 is a top view of the substrate processing apparatus when viewed from above the substrate W. The substrate W lying at an actual position 310 deviates from a substrate W′ lying at a reference position 309, as shown in FIG. 16. The control device 200 causes the substrate transport unit 202 to transport the substrate W so as to correct the amount of positional deviation determined.

The optical displacement sensors 101 and 103 have optical axes running parallel to the surface of the substrate W. The light beams 111 emitted by the optical displacement sensors 101 and 103 need not always travel on the same plane.

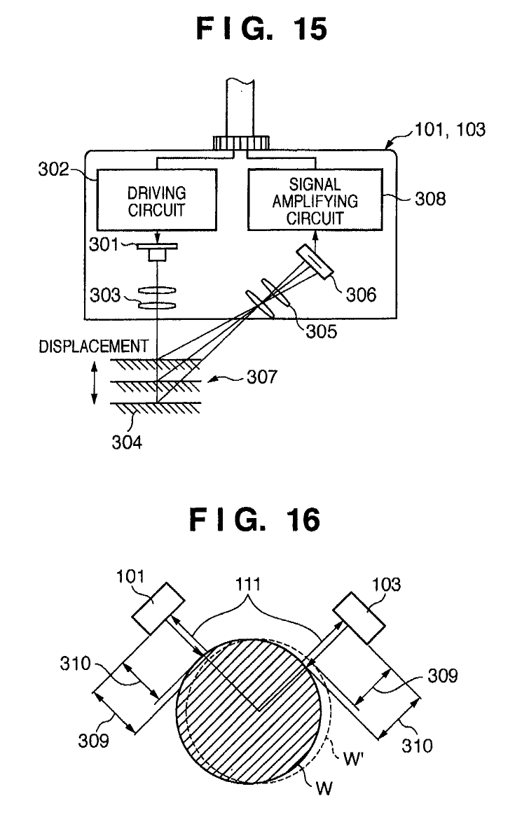

An operation for detecting the position of the substrate W as it is removed from the electrostatic chucking stage 107 will be explained with reference to FIGS. 17A, 17B, and 17C.

The optical displacement sensors 101 and 103 always emit the light beams 111, as shown in FIG. 17A. In this state, the lifting mechanism 105 stands by at a level lower than the surface of the electrostatic chucking stage 107 for the substrate W. Also in this state, the electrostatic chucking stage 107 generates an electrostatic attraction force upon being applied with a voltage. A film formation process is performed while the substrate W is held by this electrostatic attraction force and rotated by a rotation mechanism (not shown). After the film formation process is completed, the voltage application to the electrostatic chucking stage 107 is also completed

The lifting mechanism 105 is activated and lifts while holding the substrate W, as shown in FIG. 17B. At this time, when the substrate W removed from the electrostatic chucking stage 107 reaches the position of the light beam 111 emitted by one optical displacement sensor 101, the optical displacement sensor 101 measures the position of the substrate W relative to the sensor 101 upon receiving the light reflected by the peripheral face of the substrate W.

When the substrate W removed from the electrostatic chucking stage 107 reaches the position of the light beam 111 emitted by another optical displacement sensor 103, the optical displacement sensor 103 measures the position of the substrate W relative to the sensor 103 upon receiving the light reflected by the peripheral face of the substrate W, as shown in FIG. 17C.

The control device 200 can determine the position of the substrate W based on the pieces of relative position information, which have been measured by the optical displacement sensors 101 and 103.

After that, the substrate W which has reached the substrate transfer position at which substrate transfer with the substrate transport unit 202 such as a transport robot is performed is transported outside the substrate processing chamber 100 by the substrate transport unit 202, as shown in FIG. 17D.

At this time, if the position information of the substrate W determined by the control device 200 described above deviates from the reference substrate position by a predetermined threshold or more, the substrate transport unit 202 stops to prevent any troubles such as a drop of the substrate attributed to a failure in its transfer. However, if the position information of the substrate W determined by the control device 200 does not deviate from the reference substrate position so much, the control device 200 can get the substrate W using the substrate transport unit 202 by correcting the position to transfer the substrate to the substrate transport unit 202.

Although the optical displacement sensors 101 and 103 are disposed outside the substrate processing chamber 100 in the above-mentioned embodiment, their arrangement is not limited to this, and they may be disposed inside the substrate processing chamber 100.

### Second Embodiment

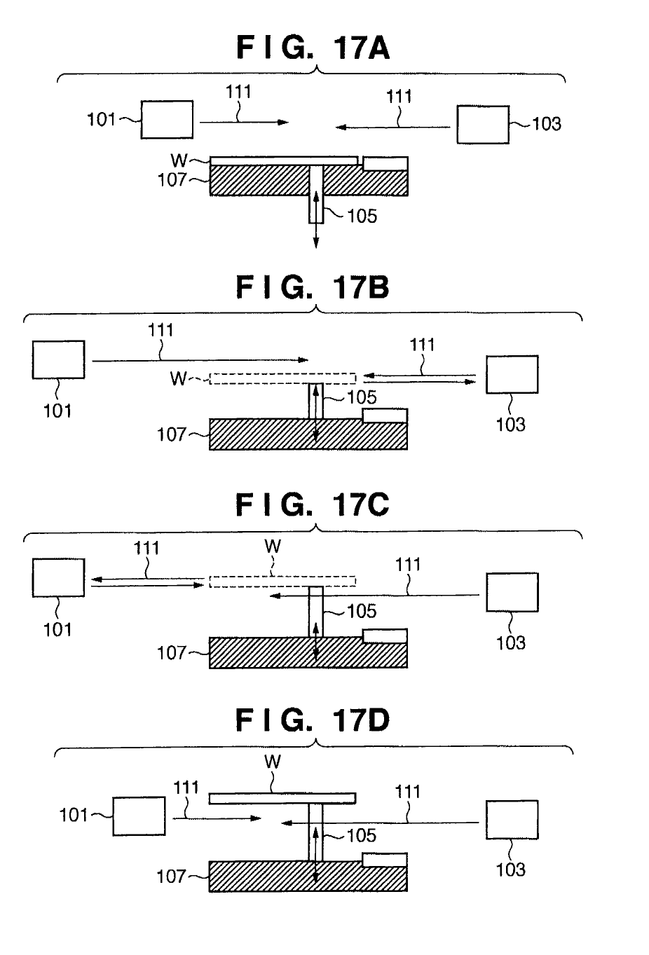

An example in which transmissive optical displacement sensors 201 and 203 are adopted as positional deviation detection units for use in the present invention will be described with reference to FIGS. 18, 19, 20, and 21. Note that the same reference numerals as in the above-mentioned first embodiment denote the same constituent elements in the second embodiment, and a detailed description thereof will not be given.

FIG. 18 is a perspective view showing a substrate processing chamber 100. The optical displacement sensors 201 and 203 are disposed outside the substrate processing chamber 100, as shown in FIG. 18. Linear light beams 222 emitted by light-projecting units 201a and 203a of the optical displacement sensors 201 and 203 pass through windows (not shown) formed in the substrate processing chamber 100, and enter collimated light line sensors 201b and 203b serving as light-receiving units of the optical displacement sensors 201 and 203 through the space above an electrostatic chucking stage 107. A substrate W lifted up by a lifting mechanism 105 traverses the linear light beams 222, thereby detecting the position of the substrate W, as in the above-mentioned embodiment.

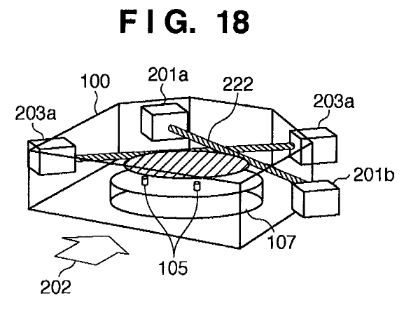

The measurement principle of the optical displacement sensors 201 and 203 used in this embodiment will be explained with reference to FIGS. 19A and 19B. Each of the optical displacement sensors 201 and 203 includes a light-projecting unit 815 for projecting a linear light beam, and a light-receiving unit 810 for receiving the light beam, as shown in FIGS. 19A and 19B.

Light emitted by a laser diode (semiconductor laser element) 502 in the light-projecting unit 815 is collimated into a uniform, parallel, linear light beam upon sequentially passing through a rectangular light-projecting window 816 and a collimator lens 504, and is guided to a measurement object 801 and the light-receiving unit 810. At this time, a shadow projected by the measurement object 801 is imaged on a one-dimensional image sensor (i.e., a line sensor) 602 of the light-receiving unit 810. The one-dimensional image sensor 602 includes, for example, a plurality of photodiodes or a CCD (Charge-Coupled Device) formed by linearly arraying a plurality of light-receiving units (pixels), and outputs the amount of received light as an electrical signal. In the case of FIGS. 19A and 19B, the light-receiving unit (pixels) includes N pixels.

The signals output from the pixels of the one-dimensional image sensor 602 are sequentially sent to a signal processing circuit (not shown) through an amplifier 813. The signal processing circuit detects the positions of edges E1 and E2 of the measurement object 801 based on the light amount distribution obtained based on the signals output from the one-dimensional image sensor 602. The signal processing circuit determines a dimension A1 of the measurement object 801 with reference to the edges E1 and E2.

The size of the light-receiving region on the one-dimensional image sensor 602 is, for example, about 35 mm width×7 μm height. Two edges E1 and E2 can be detected for the relatively small measurement object 801 shown in FIG. 19A, whereas only one edge can be detected for a relatively large substrate (with an outer diameter of 300 mm). Furthermore, the detection of the substrate position requires measurement in at least two different directions.

These collimated light line sensors need to be set on both the light-projecting and light-receiving sides before their use, in contrast to the foregoing reflective optical displacement sensor. Nevertheless, these collimated light line sensors can reliably detect the peripheral face of the substrate in combination with the vertical operation of the substrate surface using the lifting mechanism 105 free from the influence of the surface state of the peripheral face of the substrate.

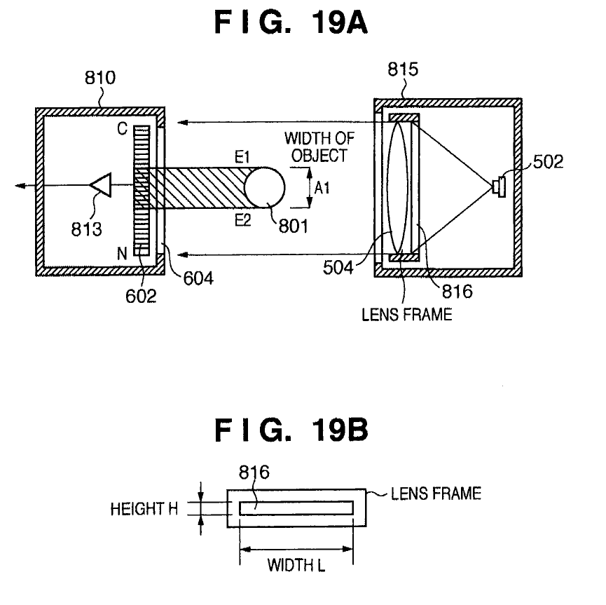

The optical displacement sensor 201 always continues applying a linear light beam 222 from the light-projecting unit 201a to the light-receiving unit 201b, as shown in FIG. 20. When the lifting mechanism 105 lifts/lowers the substrate W, the linear light beam 222 strikes the edge of the substrate W at a certain point during operation and is partially shielded, so only a non-shielded light beam 222a reaches the light-receiving unit 201b. The distance from the widthwise reference position (or the edge) of the linear light beam to the substrate W is measured based on the obtained information of the light amount distribution of the light beam.

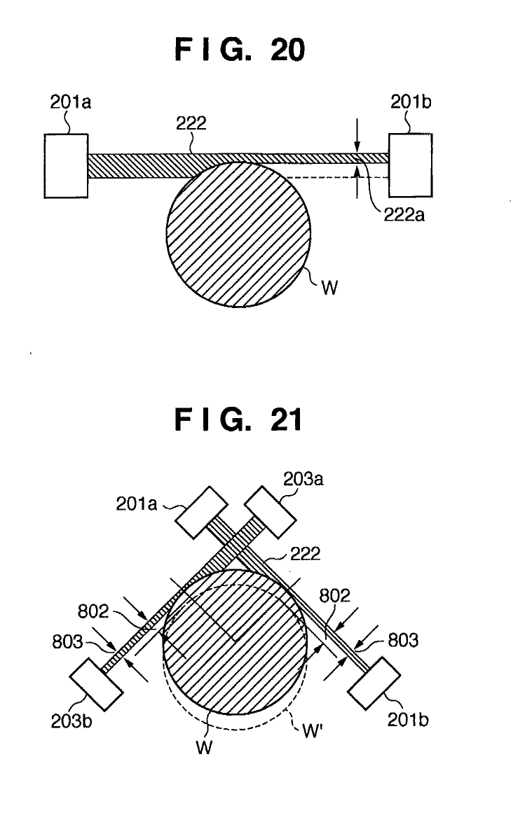

FIG. 21 is a top view of the substrate W while the two optical displacement sensors 201 and 203 detect positional deviations when viewed from above. The substrate W lying at an actual substrate position 803 deviates from a substrate W′ lying at a reference substrate position 802, as shown in FIG. 21. A control device 200 causes a substrate transport unit 202 to transport the substrate W so as to correct the amount of positional deviation determined. Note that the peripheral face of the substrate W at the reference substrate position 802 lies at a position which aligns with the outer surface of the linear light beam 222.

In this embodiment, the linear light beam 222 applied from the light-projecting unit 201a to the light-receiving unit 201b, and that applied from the collimated light line sensor 203a to the collimated line sensor 203b need not always travel on the same plane.

Although the optical displacement sensors 201 and 203 can measure the substrate positions with highest accuracy when two collimated light line sensors are disposed at the positions at which light beams from the optical displacement sensors 201 and 203 have optical axes orthogonal to each other and never impinge on the notch or orientation flat at the edge of the substrate, the directional relationship between the linear light beams 222 emitted by the optical displacement sensors 201 and 203 is not limited to this.

The position detection operation in this embodiment is basically the same as in the first embodiment. Put simply, while the two optical displacement sensors 201 and 203 emit the linear light beams 222, the lifting mechanism 105 is activated and lifts while supporting the substrate W, as shown in FIG. 18. At this time, when the substrate W removed from the electrostatic chucking stage 107 reaches the level of the linear light beam 222 emitted by the light-projecting unit of one optical displacement sensor 201, the light-receiving unit of the optical displacement sensor 201 measures the position of the peripheral face of the substrate W relative to the linear light beam 222.

When the substrate W removed from the electrostatic chucking stage 107 further lifts and reaches the level of the linear light beam 222 emitted by another collimated light line sensor 203, the sensor 203 measures the position of the peripheral face of the substrate W relative to the linear light beam 222.

The control device 200 can determine the position of the substrate W based on the pieces of relative position information of the substrate, which have been measured by the optical displacement sensors 201 and 203.

After that, the substrate W which has reached the substrate transfer position at which substrate transfer with the substrate transport unit 202 such as a transport robot is performed is transported outside the substrate processing chamber 100 by the substrate transport unit 202.

At this time, if the position information of the substrate W determined by the control device 200 described above largely deviates from the reference substrate position, the substrate transport unit 202 stops to prevent any troubles such as a drop of the substrate attributed to a failure in its transfer. However, if the position information of the substrate W determined by the control device 200 does not deviate from the reference substrate position so much, the control device 200 can get the substrate W using the substrate transport unit 202 by correcting the position to transfer the substrate to the substrate transport unit 202.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2008-197603. filed Jul. 31, 2008, 2008-228343, filed Sep. 5, 2008, and 2009-156298 filed Jun. 30, 2009, which are hereby incorporated by reference herein in their entirety.

What is claimed is:

1. A substrate alignment apparatus for aligning a substrate with a reference point, the apparatus comprising:
a plurality of columns configured to rotate about rotation axes parallel to respective axial directions thereof;
a driving mechanism configured to synchronously rotate the plurality of columns through an identical angle in an identical direction;
a detector configured to detect an amount of positional deviation of the substrate from the reference point; and
support pins which are located on upper surfaces of the plurality of columns while being spaced apart from respective rotation axes of the plurality of columns, and are configured to support the substrate,
wherein the substrate is aligned by synchronously rotating the plurality of columns through the identical angle in the identical direction by the driving mechanism based on the amount of positional deviation detected by the detector.

2. The apparatus according to claim 1, wherein
the detector is configured to detect a moving direction and an amount of movement L of the substrate, and
assuming that positions of the support pin before the movement and after the movement are axisymmetrical about a virtual line which is perpendicular to the moving direction and passes through the rotation center of the column, the substrate is aligned by rotating the plurality of columns through an angle:
2θ=2 sin⁻¹(L/2R)
where R is a distance between the rotation axis of the column and the center of the support pin, and θ is an angle formed between the virtual line and a straight line which passes through the center of the column and one of the centers of the support pin before the movement and after the movement.

3. The apparatus according to claim 2, wherein before the alignment of the substrate, each of the plurality of columns is rotated to the position of the support pin before the movement, which forms the angle θ with the virtual line, without supporting the substrate.

4. The apparatus according to claim 1, wherein the support pin has one of a semispherical distal end and a conical distal end.

5. The apparatus according to claim 1, wherein both the support pin and the column are freely rotatable about a rotation axis parallel to an axial direction of the support pin.

6. The apparatus according to claim 1, wherein the support pin falls within a region on the column.

7. The apparatus according to claim 1, further comprising
a substrate holder configured to hold the substrate, and
a ring-shaped cover configured to shield the substrate holder,
wherein the plurality of columns are located outside the substrate holder, and the ring-shaped cover is configured to rise while supporting the substrate in accordance with rising of the plurality of columns, to align the substrate through the ring-shaped cover.

8. The apparatus according to claim 1, further comprising
a substrate holder configured to hold the substrate, and
a ring-shaped cover configured to shield the substrate holder,
wherein
the plurality of columns are located outside the substrate holder,
the plurality of support pins are freely rotatable about rotation axes parallel to axial directions thereof, and the plurality of columns are freely rotatable about rotation axes parallel to axial directions thereof, and
the plurality of support pins are connected to the ring-shaped cover, which is configured to rise while supporting the substrate in accordance with rising of the plurality of columns, to align the substrate through the ring-shaped cover.

9. The apparatus according to claim 1, further comprising
a substrate holder configured to hold the substrate, and
a ring-shaped cover configured to shield the substrate holder,
wherein
the plurality of columns are located outside the substrate holder,
the plurality of support pins are freely rotatable with respect to the ring-shaped cover,
the plurality of support pins are connected to the plurality of columns, and
the ring-shaped cover is configured to rise while supporting the substrate in accordance with rising of the plurality of columns, to align the substrate through the ring-shaped cover.

10. A substrate processing apparatus comprising a substrate alignment apparatus defined in claim 1.
